(19) United States
(12) Patent Application Publication
(10) Pub. No.: US 2020/0158619 A1
(43) Pub. Date: May 21, 2020

(54) FRACTURE PRESSURE TRANSMISSION TEST APPARATUS WITH FLOWBACK MODULE

(71) Applicant: Baker Hughes, a GE company, LLC, Houston, TX (US)

(72) Inventors: Ian Lee Everhard, The Woodlands, TX (US); Grant Mackenzie, Houston, TX (US); Reza Ettehadi Osgouei, Spring, TX (US); Jesse Clark Harrison, III, Cypress, TX (US); Daniel Ellis, Kingwood, TX (US)

(73) Assignee: Baker Hughes, a GE company, LLC, Houston, TX (US)

(21) Appl. No.: 16/198,096

(22) Filed: Nov. 21, 2018

(51) Int. Cl. G01N 15/08

(52) U.S. Cl. CPC G01N 15/0826; G01N 15/0806

(57) ABSTRACT

In a fracture pressure transmission test apparatus utilizing fracture simulating slotted discs, the apparatus can assess the effectiveness of a lost circulation material (LCM) in a test fluid, allow for the assessment of the ability of the LCM to reduce pressure transmission to a tip of a fracture to prevent fracture propagation, and allow for the simulation of flow back to assess the ease of clean-up for reservoir applications.

### TECHNICAL FIELD

The present invention relates to methods and apparatus for assessing the effectiveness of lost circulation materials (LCMs) in drilling fluids, and more particularly relates, in one non-limiting embodiment, to methods and apparatus for assessing the effectiveness of LCMs in drilling fluids against simulated fractures.

### BACKGROUND

Drilling fluids used in the drilling of subterranean oil and gas wells along with other drilling fluid applications and drilling procedures are well known. In rotary drilling there are a variety of functions and characteristics that are expected of drilling fluids, also known as drilling muds, or simply “muds”. The functions of a drilling fluid include, but are not necessarily limited to, cooling and lubricating the bit, lubricating the drill pipe and other downhole equipment, carrying the cuttings and other materials from the hole to the surface, and exerting a hydrostatic pressure against the borehole wall to prevent the flow of fluids from the surrounding formation into the borehole.

Drilling fluids are typically classified according to their base fluid. In water-based muds, solid particles are suspended in water or brine. Oil can be emulsified in the water which is the continuous phase. Brine-based drilling fluids, of course, are a water-based mud (WBM) in which the aqueous component is brine. Oil-based muds (OBM) are the opposite or inverse. Solid particles are suspended in oil, and water or brine is emulsified in the oil and therefore the oil is the continuous phase. Oil-based muds can be either all-oil based or water-in-oil macroemulsions, which are also called invert emulsions. In oil-based mud, the oil may consist of any oil that may include, but is not limited to, diesel, mineral oil, esters, or alpha-olefins. Diesel based muds are abbreviated “DBM”. Non-aqueous fluids or NAF is another term used to encompass all oil-based muds, including diesel based muds.

LCMs are solid materials intentionally introduced into a fluid system to reduce and ultimately prevent the loss of whole fluid into a weak, fractured, or porous formation. LCMs may be generally fibrous, granular, or plate-like in shape. LCM manufacturers try to design slurries that will effectively bridge over and seal loss zones to inhibit or prevent fluid from being lost into those zones. LCM manufacturers grind, sieve or manufacture the solid particles into specific sizes. Often used LCMs are low cost waste products from the chemical manufacturing or food processing industries. Other LCMs like calcium carbonate and sodium chloride are mined and may have very high purities. Examples of LCMs include, but are not necessarily limited to, mica, ground peanut shells, walnut shells, cellophane, plant fibers, cottonseed hulls, ground rubber, calcium carbonate, sodium chloride, oil soluble resins, and polymeric materials. These LCMs are added to fluids to seal the openings.

LCMs are not usually added to the entire drilling fluid system. Typically when fluid losses are encountered while drilling, some of the drilling/drill-in fluid is set aside into a separate pit. These volumes may be anywhere from 20-100 bbls (barrels) (about 3-16 kiloliters). Larger sized LCM may be added to that volume and label the resulting fluid “LCM Pill”, “healer pill” or even “fluid loss control pill.” This “pill” is then pumped down to seal the losses. Similar to drilling applications, fluid loss control pills are pumped to kill wells for workovers. In these situations, larger sized bridging particles (referred to as “LCM” herein) are added to freshly made fluids and then pumped downhole to seal the openings. The goal is to form an effective bridge to reduce the amount of filtrate. Software is used to help determine not only the proper size of bridging particles required, but also the particle size distribution required for the final blend.

The effectiveness of LCMs is typically tested using a particle plugging apparatus (PPA). LCM effectiveness is also tested in high temperature high pressure (HTHP) filtration cells as well as custom-made devices where slots are cut into end caps of API filtration cells. It would be desirable if apparatus and methods could be devised to aid and improve how LCMs are tested for their effectiveness, particularly when introduced at pressures against fractures, whether these fractures are naturally occurring, caused by unintentionally exceeding the fracture gradient, or intentionally created by hydraulic fracturing. It can be important to test LCMs in a laboratory or other test setting prior to implementation in an oil field.

### SUMMARY

There is provided, in one non-limiting form, an apparatus for testing a fluid sample, where the apparatus includes a test cell having an internal volume. The test cell additionally includes a movable center piston disposed within the internal volume and dividing the internal volume between a pressure chamber and a test chamber, a slotted disc in the test chamber where the slotted disc comprises a slot in fluid communication with the test chamber, and an end cap retaining the slotted disc within the test chamber. The apparatus additionally includes a first conduit in fluid communication with the slot and a pressure applicator (e.g. a pump) in pressure communication with the pressure chamber via a second conduit. The apparatus also includes a first pressure sensor (e.g. a pressure gauge) in pressure communication with the first conduit and a valve configured to regulate test fluid transmission in the first conduit, the pressure gauge being hydraulically coupled to the first conduit at a location between the end plate and the valve.

There is additionally provided in a non-restrictive version an apparatus for testing a fluid sample, which apparatus includes a test cell. The test cell additionally includes a movable center piston disposed within the internal volume and dividing the internal volume between a pressure chamber and a test chamber, a slotted disc in the test chamber where the slotted disc comprises a slot in fluid communication with the test chamber, where the slot comprises a tapered slot having a first opening facing the test chamber and a fracture tip comprising a relatively smaller opening facing the test cap, and an end cap retaining the slotted disc within the test chamber. The apparatus also includes a first conduit in fluid communication with the slot and a first pressure applicator in pressure communication with the pressure chamber via a second conduit. Additionally the apparatus includes a first pressure sensor in pressure communication with the first conduit and a first valve configured to regulate test fluid transmission in the first conduit, the pressure gauge being hydraulically coupled to the first conduit at a location between the end plate and the first valve. Further the apparatus includes a second movable center piston within the flowback module configured to move through a second volume within the flowback module, where the second movable center piston divides the second volume between a second pressure chamber and a backflow fluid chamber for containing backflow fluid. There is a connecting conduit fluidly coupling the backflow fluid chamber and the slot, a second pressure applicator in fluid communication with the second pressure chamber via a third conduit; and a filtration collection assembly in fluid communication with the first valve.

Further there is provided in a non-restrictive embodiment, a method for assessing the effectiveness of a lost circulation material (LCM) at sealing a fracture simulated by a slotted disc comprising a slot having a fracture tip. The method includes introducing a test fluid comprising the LCM at pressure against the slotted disc within a test cell and capturing a test fluid between the fracture tip and an open first valve. Additionally the method includes creating a filter cake bridge or fracture plug by pressurizing the test fluid against the slotted disc for a pre-determined time period and completely closing the first valve to shut in the test fluid. Finally, the method includes measuring a pressure of the test fluid measuring at a first pressure sensor pressure between the closed first valve and downstream of the slotted disc to assess the effectiveness of the LCM to restrict pressure transmission through the fracture tip. Optionally, the method may also include drawing the test fluid from the first conduit into a flowback module to perform return permeability testing on a plugged slotted disc

### BRIEF DESCRIPTION OF THE DRAWINGS

FIG. 1 is a schematic diagram of one non-limiting embodiment of the fracture pressure and transmission test apparatus described herein;

FIG. 2 is a schematic diagram of another non-limiting version of the fracture pressure and transmission test apparatus described herein having a flowback module; and

FIG. 3 is a schematic graph presenting a typical dynamic pressure leak-off profile illustrating the type of test results obtainable with the apparatus and method described herein.

### DETAILED DESCRIPTION

Slotted discs have been used to simulate fractures when testing various parameters of experimental muds. A fracture pressure transmission test apparatus has been discovered to fully utilize the potential of fracture-simulating slotted discs. The apparatus and method for using it can assess the effectiveness of a LCM package or composition at sealing a simulated fracture, will allow for the assessment of the ability of the LCM to reduce pressure transmission to the tip of the fracture to prevent fracture propagation, and will allow for the simulation of flow back to assess the ease of clean-up for reservoir applications.

In more detail, a slotted disc has a generally cylindrical shape with a narrow slot through the circular faces of the disc. The slot is generally many times longer than its width. In a non-limiting embodiment, the slot length may be at least about 10 times longer than its width, alternatively at least about 50 times longer than its width, and in another non-limiting version at least about 200 times longer than its width. The slot is considered a tapered slot when the slot has a first opening that reduces or contracts in cross section to a second opening. In the context herein, the first opening faces a test chamber and the second, opposite opening faces a test cap. The second opening is smaller than the first opening which is a design aspect allowing the establishment of a fracture plugging filter cake consisting of LCM and other drilling fluid solids.

Slotted discs may be made of a variety of materials including, but not necessarily limited to, metals, such as stainless steel, nickel and aluminum based alloys; ceramics such as alumina, hydroxyapatite; and the like.

As noted, the methods of drilling through a subterranean formation with drilling fluids also include controlling filtration, controlling lost circulation, preventing drill string differential sticking, stabilizing the wellbore, and/or controlling laminated or microfractured shale. It can be important to test the characteristics of various LCMs test fluids prior to their use in field trials.

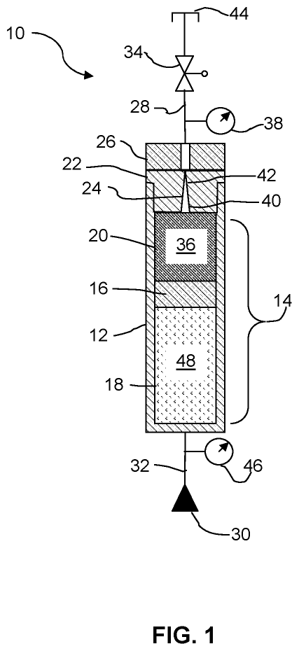

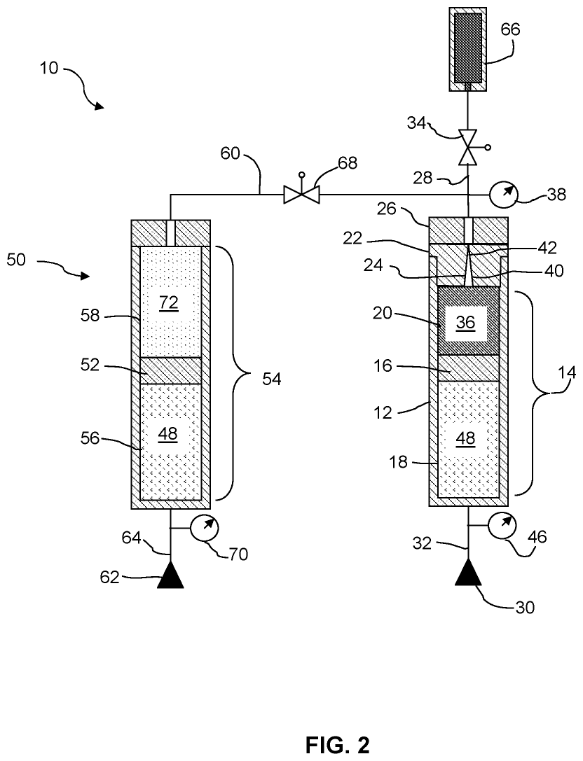

The test method is similar to a normal particle plugging apparatus (PPA) procedure but steps and components are added. One addition is a pressure sensor (e.g. a pressure transducer) on the “out” or discharge side of the cell which is situated somewhere in the line after fluid has exited the slotted disc. Downstream of the pressure sensor is a valve that is used to capture fluid between the valve and the fracture tip of the simulated slot. In this configuration, a bridge or fracture plug can be created by pressurizing the fluid against the disc for a short amount of time until flow slows down or stops (after initial “spurt loss”) and then the valve mentioned is closed to shut in that fluid. Plotting the information on the pressure transducer will test the ability of material in the fracture to restrict pressure transmission through the fracture tip. This embodiment of the apparatus will be discussed in more detail below with reference to FIG. 1. An alternate embodiment of this test apparatus involves the addition of an optional flow back cell which could allow an operator to perform return permeability type testing on a plugged fracture disc. This embodiment of the apparatus will be discussed in more detail below with reference to FIG. 2.

The apparatus and method described herein will allow determination of the dynamic pressure leak-off profile of a given LCM laden fluid. It will allow determination of the effective pressure transmission through the bridge or fracture plug (material lodged in fracture) and the effect it has on potential fracture propagation. Current tests only measure fluid filtrate and leak-off by monitoring fluid transmission at constant pressure. They only measure filtrate in contrast to measuring a pressure profile. The proposed test method described here will also feature a flow back module that will enable evaluation of the ease of removal of fracture plug (material lodged in fracture) to assess material effect on production of a treated well.

The apparatus and method described here are expected to operate at a pressure ranging from about 0 independently to about 5000 psi (about 0 to about 34 MPa); alternatively from about 500 independently to about 3000 psi (about 3.4 to about 21 MPa). As used herein, the term “independently” when used with respect to a range means that any endpoint may be used together with any other endpoint to give a suitable alternative range.

In more detail, FIG. 1 is a schematic diagram of one non-limiting embodiment of the fracture pressure and transmission test apparatus 10 which includes a test cell 12. The test cell 12 has an internal volume 14 with a movable center piston 16 disposed within the internal volume 14 dividing the internal volume 14 between a pressure chamber 18 and a test chamber 20. A slotted disc 22 having a tapered slot 24 therein is positioned at a first end of the test cell 12. The slotted disc 22 is retained and secured to the test cell 12 with an end cap 26. End cap 26 has a port therethrough providing fluid communication between the tapered slot 24 and a first conduit 28. At the opposite, second end of the test cell 12 there is a first pressure applicator 30 in pressure communication with pressure chamber 18 via a second conduit 32. First pressure applicator 30 provides hydraulic fluid 48 under pressure into pressure chamber 18.

As used herein pressure applicators may take a variety of forms including, but not necessarily limited to, pumps of a wide variety of designs, a motor driving a gear or shaft, compressed air and gas, hydraulic pumps, and the like.

Additionally, there is a first valve 34 configured to regulate test fluid 36 transmission in the first conduit 28 and a pressure sensor 38 that is hydraulically coupled to the first conduit 28 at a location between the end plate 26 and the first valve 34. As used herein suitable pressure sensors include, but are not limited to, pressure transducers, pressure gauges, and the like.

In one non-limiting embodiment the tapered slot 24 has a first opening 40 facing the test chamber and a fracture tip 42 comprising a relatively smaller opening facing the test cap 26.

The test apparatus 10 also includes a drain 44 in the first conduit 28 downstream from the first valve 34. It may also include a second pressure sensor 46 in the second conduit 32.

A second, optional embodiment of the fracture pressure and transmission test apparatus 10 includes an optional flowback module 50 as schematically illustrated in FIG. 2. Common components have the same reference numbers as shown in FIG. 1. The flowback module 50 includes a second movable center piston 52 within the flowback module 50 configured to move through a second volume 54 within the flowback module 50, where the second movable center piston 52 divides the second volume 54 between a second pressure chamber 56 and a backflow fluid chamber 58 containing backflow fluid 72. As used herein, the term “fluid” encompasses liquids and gases. Thus, the backflow fluid 72 may be a liquid and/or a gas.

In this embodiment there is a connecting conduit 60 fluidly coupling the backflow fluid chamber 58 and the slot 24 to permit backflow fluid 72 to flow from slot 24 to backflow fluid chamber 58. A second pressure applicator 62 is present in fluid communication with the second pressure chamber 56 via a third conduit 64. A filtration collection assembly 66 is present in fluid communication with the first valve 34. There may additionally present a second valve 68 in the connecting conduit 60 and a third pressure sensor 70 in the third conduit 64.

In operation, the fracture pressure and transmission test apparatus 10 may, in one non-limiting embodiment, assess the effectiveness of a LCM at sealing a fracture simulated by a slotted disc 22 which contains a slot 24 having a fracture tip 42. The method includes introducing a test fluid 36 comprising the LCM at pressure against the slotted disc 22 within the test cell 12, by moving the first movable center piston 16 by applying pressure to the hydraulic fluid 38 in first pressure chamber 18 by the action of the first pressure application 30, which as noted may be a pump. Test fluid 36 is captured between the fracture tip 42 and a partially closed first valve 34. A bridge or fracture plug (not shown) may be created by pressurizing the test fluid 36 against the slotted disc 22 for a pre-determined time period. Suitable pre-determined time periods may range between about 0 independently to about 30 minutes; alternatively between about 1 independently to about 5 minutes.

Subsequently, first valve 34 is completely closing to shut in the test fluid 36 in the test chamber 20. Then the pressure of the test fluid 36 is measured at the first pressure sensor 36 pressure downstream of the slotted disc 22 to assess the effectiveness of the LCM to restrict pressure transmission through the fracture tip 42.

The method may further include filtrate in a filtrate collection assembly 66 downstream from the first valve 34. Filtrate collection is an important parameter to monitor as it allows an operator to identify the amount of time, fluid, and pressure required to build an initial filter cake. By allowing fluid to pass through the filter for a given amount of time before closing the first valve and monitoring pressure, the establishment of a suitable filter cake or fracture plug becomes possible.

Optionally the operation of the apparatus 10 additionally includes drawing the test fluid 36 from the first conduit 28 into a flowback module 50 to perform return permeability testing on a plugged slotted disc 22. More specifically this may include flowing backflow fluid 72 from the slot 24 through a connecting conduit 60 to backflow fluid chamber 58 in a backflow module 50. This optional part of the method also includes moving a second movable piston 52 in the backflow fluid chamber 58, where the second movable center piston 52 divides a second volume 54 between a second pressure chamber 56 and the backflow fluid chamber 58. Finally, hydraulic fluid 48 passes or flows from the second pressure chamber 56 into a third conduit 64 which is in pressure communication with a third pressure sensor 70. Second pressure applicator 62 in fluid communication with third conduit 64 may be used to add pressure to the second pressure chamber 56 to move second movable center position in the direction toward backflow fluid chamber 50, for instance to move backflow fluid 72 to drain 44 or filtration collection assembly 66.

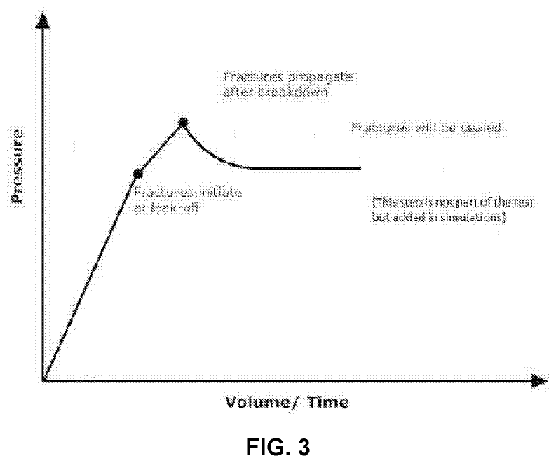

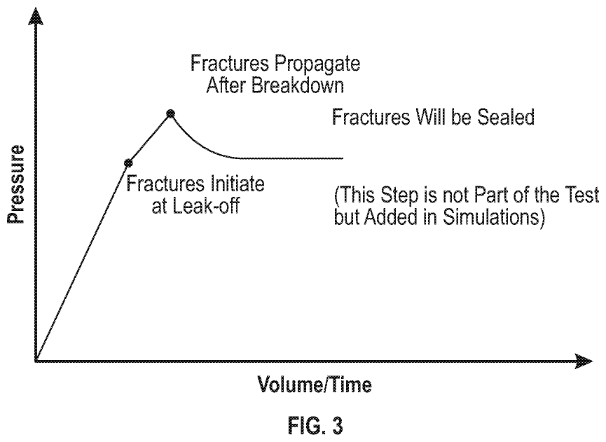

The apparatus and method described herein will permit determination of a dynamic pressure leak-off profile of a given LCM-laden test fluid. FIG. 3 presents a schematic graph presenting a typical dynamic pressure leak-off profile illustrating the type of test results obtainable. It will also permit determination of effective pressure transmission through the bridge or fracture plug, that is, material lodged in a fracture, and the effect that it has on potential fracture propagation. Current tests only measure the fluid filtrate and leak-off by monitoring fluid transmission at constant pressure. As noted, the apparatus and method described here may also have the optional flow back module that will allow evaluation of the ease of removal of the bridge or fracture plug, i.e. material lodged in a fracture, to assess material effect on the production of a treated well. Results reported by means of pressure transmission rather than filtrate volume have direct application to values reported in a field environment.

It will be appreciated that the apparatus and method are equally applicable to water-based fluids and/or oil-based fluids as well as emulsion fluids, particularly oil-in-water drilling fluids.

There is also no criticality about the dimensions of the apparatus described herein. And while there are no particular restrictions as to where the apparatus may be placed or the environment where the method may be practiced, in one non-limiting embodiment the apparatus would function well in a laboratory environment.

In the foregoing specification, the invention has been described with reference to specific embodiments thereof, and has been suggested as effective in providing effective methods and apparatus for testing fluids, particularly fluid samples containing LCMs. However, it will be evident that various modifications and changes may be made thereto without departing from the broader scope of the invention. Accordingly, the specification is to be regarded in an illustrative rather than a restrictive sense. For example, specific combinations of components for, designs for components, and steps for testing the fluid samples, such as test cells, pistons, internal volumes, pressure chambers, test chambers, slotted discs, tapered slots, fracture tips, end caps, conduits, pressure applicators, pressure sensors, valves, flowback modules, backflow fluid chambers, filtration collection assemblies falling within the claimed parameters, but not specifically identified or tried in a particular fluid to improve the lubricity as described herein, are anticipated to be within the scope of this invention. Furthermore, measuring fluid properties other than those specifically discussed herein may also be improved, as well as the fluid properties themselves improved as a result of practicing the methods and apparatus described herein.

The present invention may suitably comprise, consist or consist essentially of the elements disclosed and may be practiced in the absence of an element not disclosed. For example, there is provided an apparatus for testing a fluid sample comprising, consisting essentially of, or consisting of a test cell having an internal volume, the test cell comprising, consisting essentially of or consisting of: a movable center piston disposed within the internal volume and dividing the internal volume between a pressure chamber and a test chamber, a slotted disc in the test chamber where the slotted disc comprises, consists essentially of, or consists of a slot in fluid communication with the test chamber, and an end cap retaining the slotted disc within the test chamber; a first conduit in fluid communication with the slot; a pressure applicator in pressure communication with the pressure chamber via a second conduit; a first pressure sensor in pressure communication with the first conduit; a valve configured to regulate test fluid transmission in the first conduit, and a pressure sensor hydraulically coupled to the first conduit at a location between the end plate and the valve.

Further there is provided in another non-restrictive version a method for assessing the effectiveness of a lost circulation material (LCM) at sealing a fracture simulated by a slotted disc comprising a slot having a fracture tip, the method comprising, consisting essentially of, or consisting of introducing a test fluid comprising the LCM at pressure against the slotted disc within a test cell; capturing a test fluid between the fracture tip and a partially closed first valve; creating a bridge or fracture plug by pressurizing the test fluid against the slotted disc for a pre-determined time period; completely closing the first valve to shut in the test fluid; and measuring a pressure of the test fluid measuring at a first pressure sensor pressure downstream of the slotted disc to assess the effectiveness of the LCM to restrict pressure transmission through the fracture tip.

As used herein, the terms “comprising,” “including,” “containing,” “characterized by,” and grammatical equivalents thereof are inclusive or openended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and accompanying drawings and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

1. An apparatus for testing a fluid sample comprising:
a test cell having an internal volume, the test cell comprising:
a movable center piston disposed within the internal volume and dividing the internal volume between a pressure chamber and a test chamber;
a slotted disc in the test chamber where the slotted disc comprises a slot in fluid communication with the test chamber; and
an end cap retaining the slotted disc within the test chamber;
a first conduit in fluid communication with the slot;
a pressure applicator in pressure communication with the pressure chamber via a second conduit;
a valve configured to regulate test fluid transmission in the first conduit, and
a first pressure sensor hydraulically coupled to the first conduit at a location between the end cap and the valve.

2. The test apparatus of claim 1 where the slot comprises a tapered slot having a first opening facing the test chamber and a fracture tip comprising a relatively smaller opening facing the end cap.

3. The test apparatus of claim 1 further comprising a drain in the first conduit downstream from the first valve.

4. The test apparatus of claim 1 further comprising a second pressure sensor in the second conduit.

5. The test apparatus of claim 1 where the valve is a first valve and the test apparatus further comprises a flowback module comprising:
a second movable center piston within the flowback module configured to move through a second volume within the flowback module, where the second movable center piston divides the second volume between a second pressure chamber and a backflow fluid chamber;
a connecting conduit fluidly coupling the backflow fluid chamber and the slot;
a second pressure applicator in fluid communication with the second pressure chamber via a third conduit; and
a filtration collection assembly in fluid communication with the first valve.

6. The test apparatus of claim 5 further comprising a second valve in the connecting conduit.

7. The test apparatus of claim 5 further comprising a third pressure sensor in the third conduit.

8. The test apparatus of claim 1 where the pressure applicator is a pump.

9. The test apparatus of claim 1 where the pressure sensor is selected from the group consisting of a pressure transducer and a pressure gauge.

10. An apparatus for testing a fluid sample, comprising:
a test cell having an internal volume, the test cell comprising:
a movable center piston disposed within the internal volume and dividing the internal volume between a pressure chamber and a test chamber;
a slotted disc in the test chamber where the slotted disc comprises a slot in fluid communication with the test chamber, where the slot comprises a tapered slot having a first opening facing the test chamber and a fracture tip comprising a relatively smaller opening facing the test cap;
an end cap retaining the slotted disc within the test chamber;
a first conduit in fluid communication with the slot;
a first pressure applicator in pressure communication with the pressure chamber via a second conduit;
a first pressure sensor in pressure communication with the first conduit;
a first valve configured to regulate test fluid transmission in the first conduit, the first pressure sensor being hydraulically coupled to the first conduit at a location between the end plate and the first valve;
a second movable center piston within the flowback module configured to move through a second volume within the flowback module, where the second movable center piston divides the second volume between a second pressure chamber and a backflow fluid chamber;
a connecting conduit fluidly coupling the backflow fluid chamber and the slot;
a second pressure applicator in fluid communication with the second pressure chamber via a third conduit; and
a filtration collection assembly in fluid communication with the first valve.

11. The test apparatus of claim 10 further comprising a second pressure sensor in the second conduit.

12. The test apparatus of claim 10 further comprising a second valve in the connecting conduit.

13. The test apparatus of claim 10 further comprising a third pressure sensor in the third conduit.

14. The test apparatus of claim 10 where the first pressure applicator is a pump.

15. The test apparatus of claim 10 where the pressure sensor is selected from the group consisting of a pressure transducer and a pressure gauge.

16. A method for assessing the effectiveness of a lost circulation material (LCM) at sealing a fracture simulated by a slotted disc comprising a slot having a fracture tip, the method comprising:
introducing a test fluid comprising the LCM at pressure against the slotted disc within a test cell;
capturing a test fluid between the fracture tip and an open first valve;
creating a bridge or fracture plug by pressurizing the test fluid against the slotted disc for a pre-determined time period;
completely closing the first valve to shut in the test fluid; and
measuring a pressure of the test fluid measuring at a first pressure sensor pressure between the closed first valve downstream of the slotted disc to assess the effectiveness of the LCM to restrict pressure transmission through the fracture tip.

17. The method of claim 16 further comprising collecting filtrate in a filtrate collection assembly downstream from the first valve.

18. The method of claim 16 further comprising flowing the test fluid from the slot through a first conduit, the first pressure sensor being in pressure communication with the first conduit and a first valve in the first conduit downstream from the first pressure sensor.

19. The method of claim 18 further comprising drawing the test fluid from the first conduit into a flowback module to perform return permeability testing on a plugged slotted disc.

20. The method of claim 16 further comprising:
flowing test fluid from the slot through a connecting conduit to backflow fluid chamber in a flowback module;
moving a second movable center piston in the backflow fluid chamber, where the second movable center piston divides a second volume between a second pressure chamber and the backflow fluid chamber; and
flowing hydraulic fluid from the second pressure chamber into a third conduit in pressure communication with a third pressure sensor.
